(19) United States
(12) Patent Application Publication
(10) Pub. No.: US 2019/0356450 A1
(43) Pub. Date: Nov. 21, 2019

(54) CONTROL SIGNALING CONFIGURATION METHOD AND APPARATUS

(71) Applicant: ZTE CORPORATION, Shenzhen, Guangdong (CN)

(72) Inventors: Qingchun HE, Shenzhen (CN); Yin GAO, Shenzhen (CN); He HUANG, Shenzhen (CN); Yang LIU, Shenzhen (CN)

(21) Appl. No.: 16/476,228

(22) PCT Filed: Dec. 14, 2017
(86) PCT No.: PCT/CN2017/116113

§ 371 Date: Jul. 5, 2019

(30) Foreign Application Priority Data
Jan. 5, 2017 (CN) 201710008457.0

(51) Int. Cl. H04L 5/00; H04W 72/04

(52) U.S. Cl. CPC H04L 5/0053; H04W 28/0278; H04W 72/0406

(57) ABSTRACT

Provided are a control signaling configuration method and device. The method comprises: a first network element generates control information; the first network element sends the control information to a second network element by means of an interface between the first network element and the second network element. The present invention resolves the technical problem in the related art of failure of network elements to understand each other, thereby improving the service processing efficiency of the network elements.

### TECHNICAL FIELD

The present disclosure relates to the field of communications, in particular, to a control signaling configuration method and a control signaling configuration apparatus.

### BACKGROUND

In 5G mobile communication, a large number of connections and users' higher rate requirements pose a great challenge to the transmission capacity of a common public radio interface (CPRI) between a base band unit (BBU) and a remote radio unit (RRU) in Long Term Evolution (LTE). Since transmitted through the CPRI are IQ signals that have undergone physical layer code modulation or the like, the CPRI has high requirements for transmission delay and bandwidth. After the 5G air interface rate has been increased to tens of Gbps, the traffic requirements of the CPRI interface will be increased to the Tbps level, putting tremendous pressure on both the network deployment costs and the network deployment difficulty. Therefore, in 5G, it is needed to redefine the division mode of the CPRI. In the division mode of the CPRI, the transmission capacity, the transmission delay, the convenient deployment and other aspects are considered. For example, in terms of non-ideal fronthaul transmission, a delay-insensitive network function is placed in a first network element (for example, a centralized unit (CU)), a delay-sensitive network function is placed in a second network element (for example, a distributed unit (DU)). Transmission is performed between the first network element and the second network element via ideal or non-ideal fronthaul.

A first control plane protocol entity (for example, a radio resource control (RRC) entity) is located in the first network element. The first control plane protocol entity generates control signaling, maintains establishment and/or modification and/or release of a radio bearer, and maintains parameter updates of a second control plane entity, a third control plane entity, a fourth control plane entity, and a physical layer. The function of the second protocol entity is similar to and enhanced on the basis of the PDCP function of the LTE system. The function of the third protocol entity is similar to and enhanced on the basis of the RLC function of the LTE system. The function of the fourth protocol entity is similar to and enhanced on the basis of the medium access control (MAC) function of the LTE system. The first network element communicates with the second network element through the fronthaul interface. Thus, the related entity configuration information in the second network element needs to be sent from the first network element to the second network element through the interface between the first network element and the second network element. Moreover, the terminal-related configuration also needs to be sent from the first network element to the second network element via the interface and further sent from the second network element to the terminal. Likewise, the feedback message of the terminal and the feedback message of the second network element are also sent to the first network element through the interface.

No effective solution has been found to address the preceding problems in related technology.

### SUMMARY

A control signaling configuration method and a control signaling configuration apparatus are provided in embodiments of the present disclosure to solve at least the problem in the related technology that network elements cannot understand each other.

According to an embodiment of the present disclosure, a control signaling configuration method is provided. The method includes generating, by a first network element, control information according to service type information; and sending, by the first network element, the control information to a second network element through an interface between the first network element and the second network element.

Optionally, the first network element and the second network element are defined according to at least one of different processing delay requirements, different transmission capacity requirements, or different service types.

Optionally, the first network element generates the control information according to service type information, where the service type information includes at least one of a service type, a radio bearer (RB), a logical channel (LCH), a physical-layer parameter numerology, or a network slice.

Optionally, the first network element includes at least one of a first control plane protocol entity, a second protocol entity, part or all of a third protocol entity, part or all of a fourth protocol entity, or part or all of a physical layer.

Optionally, the second network element includes at least one of part or all of a second protocol entity, part or all of a third protocol entity, part or all of a fourth protocol entity, part or all of a physical layer, or a radio frequency unit.

Optionally, the control information includes configuration information. The configuration information includes at least one of slice configuration information, numerology configuration information, grant-free configuration information, logic channel priority (LCP) configuration information, discontinuous reception (DRX) configuration information, hybrid automatic repeat request (HARQ) configuration information, buffer status report (BSR) configuration information, power headroom report (PHR) configuration information, or measurement configuration information.

Optionally, generating, by the first network element, the control information includes generating, by the first network element, the control information when the first network element performs at least one of configuration information addition, configuration information deletion or configuration information updating.

Optionally, sending, by the first network element, the control information to the second network element through the interface between the first network element and the second network element includes sending, by the first network element, the control information to the second network element after the first network element performs at least one of configuration information addition, configuration information deletion or configuration information updating; or sending, by the first network element, the control information to the second network element after the first network element receives a request for acquiring the configuration information.

Optionally, generating, by the first network element, the control information includes configuring, by the first network element, the control information through at least one of a dedicated process or a common process.

Optionally, after sending, by the first network element, the control information to the second network element through the interface between the first network element and the second network element, the method further includes receiving, by the first network element, feedback information sent by the second network element in response to the control information.

Optionally, the feedback information includes at least one of feedback information for flow control, inter-layer state indication information, acknowledgement (ACK)/non-acknowledgement (NACK) state indication information, measurement result report information, or parameter information of an entity in the second network element.

Optionally, the slice configuration information includes at least one of a mapping relationship between a slice and a radio bearer (RB), a mapping relationship between the slice and a logical channel (LCH), a mapping relationship between the slice and a service type, a mapping relationship between the slice and a physical resource or resource pool, a slice priority, a quality of service (QoS) level of the slice, a maximum transmission rate of the slice, or a percentage of resources occupied by the slice.

Optionally, the numerology configuration information includes at least one of a mapping relationship between numerology and a radio bearer (RB), a mapping relationship between the numerology and a logical channel (LCH), a mapping relationship between the numerology and a service type, or a mapping relationship between the numerology and a physical resource or a physical resource pool.

Optionally, the grant-free configuration information includes at least one of a mapping relationship between grant-free and a radio bearer (RB), a mapping relationship between the grant-free and a logical channel (LCH), or a mapping relationship between the grant-free and a service type.

Optionally, the LCP configuration information includes at least one of a mapping relationship between an LCP and a radio bearer (RB), a mapping relationship between the LCP and a logical channel (LCH), or a mapping relationship between the LCP and a service type.

Optionally, the DRX configuration information includes at least one of a mapping relationship between DRX and a radio bearer (RB), a mapping relationship between the DRX and a logical channel (LCH), or a mapping relationship between the DRX and a service type.

Optionally, the HARQ configuration information includes at least one of a mapping relationship between an HARQ and a radio bearer (RB), a mapping relationship between the HARQ and a logical channel (LCH), or a mapping relationship between the HARQ and a service type.

Optionally, the BSR configuration information includes at least one of a BSR being reported in unit of logical channel group or the BSR being reported in unit of logical channel.

Optionally, the PHR configuration information includes at least one of a terminal being configured to calculate a power headroom according to total power or the terminal being configured to calculate the power headroom according to power allocated on multiple links.

Optionally, content is transmitted between the first network element and the second network element in at least one of the following formats: a container or a plaintext.

According to an embodiment of the present disclosure, a control signaling configuration apparatus is provided. The apparatus includes a generating module, which is configured to generate control information; and a sending module, which is configured to send the control information to a second network element through an interface between a first network element and the second network element.

Optionally, the generating module generates the control information according to service type information, where the service type information includes at least one of a service type, a radio bearer (RB), a logical channel (LCH), a physical-layer parameter numerology, or a network slice.

Optionally, the control information includes configuration information. The configuration information includes at least one of slice configuration information, numerology configuration information, grant-free configuration information, logic channel priority (LCP) configuration information, discontinuous reception (DRX) configuration information, hybrid automatic repeat request (HARQ) configuration information, buffer state report (BSR) configuration information, power headroom report (PHR) configuration information, or measurement configuration information.

Optionally, the generating module includes a generating unit, which is configured to generate the control information when at least one of configuration information addition, configuration information deletion or configuration information updating is performed.

Optionally, the sending module includes a first sending unit, which is configured to send the control information to the second network element after at least one of configuration information addition, configuration information deletion or configuration information updating is performed, or a second sending unit, which is configured to make the first network element send the control information to the second network element after a request for acquiring the configuration information is received.

According to an embodiment of the present disclosure, a storage medium is provided. The storage medium is arranged to store program codes for performing the steps of generating control information according to service type information; and sending the control information to a second network element through an interface between a first network element and the second network element. The first network element and the second network element are defined according to at least one of different processing delay requirements, different transmission capacity requirements, or different service types.

According to the present disclosure, a first network element generates control information; and the first network element sends the control information to a second network element through an interface between the first network element and the second network element. Control information exchange is realized between network elements upon receptions at the network elements, so service type information of the network elements can be understood by each other. Thus, the second network element can perform a corresponding operation according to a configuration message of the first network element included in the control information. This solves the problem in related technology that network elements cannot understand each other, thereby improving the service processing efficiency of the network elements.

### BRIEF DESCRIPTION OF DRAWINGS

The accompanying drawings described herein are used to provide a further understanding of the present disclosure and form a part of the present disclosure. The illustrative embodiments and descriptions thereof in the present disclosure are used to explain the present disclosure and not to limit the present disclosure in an improper way. In the accompanying drawings:

FIG. 1A is a flowchart of a control signaling configuration method according to an embodiment of the present disclosure;

FIG. 1B is a flowchart of a control signaling configuration method according to an embodiment of the present disclosure;

FIG. 2 is a schematic diagram of a control plane protocol architecture at a wireless network side or a terminal side according to the present disclosure;

FIG. 3 is a block diagram of a control signaling configuration apparatus according to an embodiment of the present disclosure;

FIG. 4 is a schematic diagram of a fronthaul interface between a first network element and a second network element according to the present disclosure;

FIG. 5 is a flowchart of transmission of configuration information between a first network element and a second network element according to the present disclosure;

FIG. 6 is a flowchart of generation and/or transmission of slice configuration information according to the present disclosure;

FIG. 7 is a flowchart of configuration of numerology mapping relationship according to the present disclosure;

FIG. 8 is a flowchart of configuration of DRX mapping relationship according to the present disclosure;

FIG. 9 is a flowchart of configuration of HARQ mapping relationship according to the present disclosure;

FIG. 10 is a flowchart of configuration of grant-free mapping relationship according to the present disclosure;

FIG. 11 is a flowchart of configuration of LCP mapping relationship according to the present disclosure; and

FIG. 12 is a flowchart of transmission of configuration information of BSR/PHR/measurement configuration according to the present disclosure.

### DETAILED DESCRIPTION

The present disclosure will be detailed below with reference to the accompanying drawings in conjunction with the embodiments. If not in collision, the embodiments described herein and the features in the embodiments can be combined with each other.

It is to be noted that the terms “first”, “second” and the like in the description, claims and drawings of the present disclosure are used to distinguish between similar objects and are not necessarily used to describe a particular order or sequence.

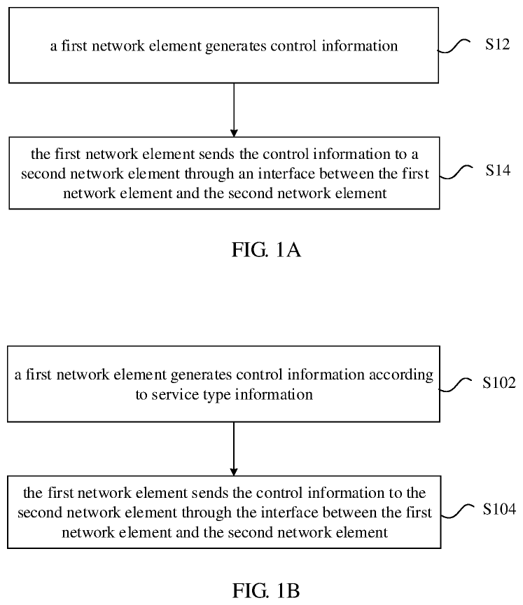

In an embodiment, a control signaling configuration method is provided. FIG. 1A is a flowchart of the control signaling configuration method according to the embodiment of the present disclosure. As shown in FIG. 1A, the method includes the steps described below.

In step S12, a first network element generates control information.

In step S14, the first network element sends the control information to a second network element through an interface between the first network element and the second network element.

Through the preceding steps, the first network element generates control information and sends the control information to the second network element through the interface between the first network element and the second network element. Control information exchange is realized between network elements upon receptions at the network elements, so service type information of the network elements can be understood by each other. Thus, the second network element can perform a corresponding operation according to a configuration message of the first network element included in the control information, solving the problem in related technology that network elements cannot understand each other and improving service processing efficiency of the network elements.

In an optional implementation mode according to the embodiment, the first network element generates the control information according to service type information. The service type information includes at least one of a service type, a radio bearer (RB), a logical channel (LCH), a physical-layer parameter numerology, or a network slice.

In an optional implementation mode according to the embodiment, the control information includes configuration information. The configuration information includes at least one of slice configuration information, numerology configuration information, grant-free configuration information, logic channel priority (LCP) configuration information, discontinuous reception (DRX) configuration information, hybrid automatic repeat request (HARQ) configuration information, buffer status report (BSR) configuration information, power headroom report (PHR) configuration information, or measurement configuration information.

In an optional implementation mode according to the embodiment, generating, by the first network element, the control information includes: generating, by the first network element, the control information when the first network element performs at least one of configuration information addition, configuration information deletion or configuration information updating.

In an optional implementation mode according to the embodiment, sending, by the first network element, the control information to the second network element through the interface between the first network element and the second network element includes: sending, by the first network element, the control information to the second network element after the first network element performs at least one of configuration information addition, configuration information deletion or configuration information updating; or sending, by the first network element, the control information to the second network element after the first network element receives a request for acquiring the configuration information.

In an optional implementation mode according to the embodiment, generating, by the first network element, the control information includes: configuring, by the first network element, the control information through at least one of a dedicated process or a common process.

In an optional implementation mode according to the embodiment, after sending, by the first network element, the control information to the second network element through the interface between the first network element and the second network element, the method further includes receiving, by the first network element, feedback information sent by the second network element in response to the control information.

In an optional implementation mode according to the embodiment, the feedback information includes at least one of feedback information for flow control, inter-layer state indication information, acknowledgement (ACK)/non-acknowledgement (NACK) state indication information, measurement result report information, or parameter information of an entity in the second network element.

In an optional implementation mode according to the embodiment, the slice configuration information includes at least one of a mapping relationship between a slice and a radio bearer (RB), a mapping relationship between the slice and a logical channel (LCH), a mapping relationship between the slice and a service type, a mapping relationship between the slice and a physical resource or a physical resource pool, a slice priority, a quality of service (QoS) level of the slice, a maximum transmission rate of the slice, or a percentage of resources occupied by the slice.

In an optional implementation mode according to the embodiment, the numerology configuration information includes at least one of a mapping relationship between numerology and a radio bearer (RB), a mapping relationship between the numerology and a logical channel (LCH), a mapping between the numerology and a service type, or a mapping between the numerology and a physical resource or a physical resource pool.

In an optional implementation mode according to the embodiment, the grant-free configuration information includes at least one of a mapping relationship between grant-free and a radio bearer (RB), a mapping relationship between the grant-free and a logical channel (LCH), or a mapping relationship between the grant-free and a service type.

In an optional implementation mode according to the embodiment, the LCP configuration information includes at least one of a mapping relationship between an LCP and a radio bearer (RB), a mapping relationship between the LCP and a logical channel (LCH), or a mapping relationship between the LCP and a service type.

In an optional implementation mode according to the embodiment, the DRX configuration information includes at least one of a mapping relationship between DRX and a radio bearer (RB), a mapping relationship between the DRX and a logical channel (LCH), or a mapping relationship between the DRX and a service type.

In an optional implementation mode according to the embodiment, the HARQ configuration information includes at least one of a mapping relationship between an HARQ and a radio bearer (RB), a mapping relationship between the HARQ and a logical channel (LCH), or a mapping relationship between the HARQ and a service type.

In an optional implementation mode according to the embodiment, the BSR configuration information includes at least one of a BSR being reported in unit of logical channel group or the BSR being reported in unit of logical channel.

In an optional implementation mode according to the embodiment, the PHR configuration information includes at least one of: a terminal being configured to calculate a power headroom according to total power or the terminal being configured to calculate the power headroom according to power allocated on multiple links.

In an optional implementation mode according to the embodiment, content is transmitted between the first network element and the second network element in at least one of the following formats: a container or a plaintext.

In an optional implementation mode according to the embodiment, the first network element and the second network element are defined according to at least one of different processing delay requirements, different transmission capacity requirements, or different service types.

In an embodiment, a control signaling configuration method is provided. FIG. 1B is a flowchart of the control signaling configuration method according to the embodiment of the present disclosure. As shown in FIG. 1B, the method includes the steps described below.

In step S102, a first network element generates control information according to service type information.

In step S104, the first network element sends the control information to a second network element through an interface between the first network element and the second network element.

Through the preceding steps, the first network element generates control information according to service type information and sends the control information to the second network element through the interface between the first network element and the second network element. Control information exchange is realized between network elements upon receptions at the network elements, so service type information of the network elements can be understood by each other. Thus, the second network element can perform a corresponding operation according to a configuration message of the first network element included in the control information, solving the problem in related technology that network elements cannot understand each other and improving the service processing efficiency of the network elements.

Optionally, the first network element and the second network element are defined according to at least one of different processing delay requirements, different transmission capacity requirements, or different service types.

Optionally, the first network element that performs the preceding steps includes, but is not limited to, at least one of a first control plane protocol entity, a second protocol entity part or all of a third protocol entity, part or all of a fourth protocol entity, or part or all of a physical layer. The second network element includes, but is not limited to, at least one of part or all of a second protocol entity, part or all of a third protocol entity, part or all of a fourth protocol entity, part or all of a physical layer, or a radio frequency unit. The content included in the second network element is related to the entity content included in the first network element. In a case that the first network element includes first control plane protocol entities and second protocol entities, the second network element includes third protocol entities, fourth protocol entities, part or all of physical layers, and the radio frequency unit. Each of the first network element and the second network element may be not only one network element entity. In a case that the second network element is further divided into a third network element and a fourth network element, the fourth network element includes at least one of part or all of physical layers or the radio frequency unit.

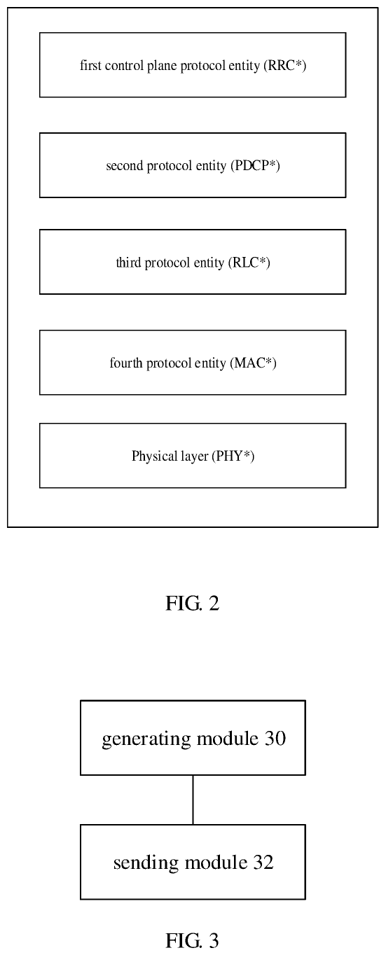

FIG. 2 is a schematic diagram of a control plane protocol architecture at a wireless network side or a terminal side according to the present disclosure. In FIG. 2, a first control plane protocol entity may be a radio resource control entity, which generates a control signaling, maintains at least one of establishment, modification or release of a radio bearer, and maintains parameter updates of a second control plane entity, a third control plane entity, a fourth control plane entity, and a physical layer. The function of the second protocol entity is similar to and enhanced on the basis of the Packet Data Convergence Protocol (PDCP) function of the LTE system. The function of the third protocol entity is similar to and enhanced on the basis of the radio link control (RLC) function of the LTE system. The function of the fourth protocol entity is similar to and enhanced on the basis of the medium access control (MAC) function of the LTE system.

Optionally, the service type information in the embodiment includes at least one of a service type, a radio bearer (RB), a logical channel (LCH), a physical-layer parameter numerology, or a network slice. The physical layer parameter numerology includes at least one of a subcarrier spacing, a symbol interval, a subframe format, a quantity of symbols included in a subframe, a multi-access mode, or a transmission time interval.

Optionally, the control information includes configuration information. The configuration information includes at least one of slice configuration information, numerology configuration information, grant-free configuration information, logic channel priority (LCP) configuration information, discontinuous reception (DRX) configuration information, hybrid automatic repeat request (HARQ) configuration information, buffer status report (BSR) configuration information, power headroom report (PHR) configuration information, or measurement configuration information.

In an optional implementation mode according to the embodiment, generating, by the first network element, the control information according to the service type information includes generating, by the first network element, the control information according to the service type information when the first network element performs at least one of configuration information addition, configuration information deletion or configuration information updating.

In an optional implementation mode according to the embodiment, sending, by the first network element, the control information to the second network element through the interface between the first network element and the second network element includes sending, by the first network element, the control information to the second network element after the first network element performs at least one of configuration information addition, configuration information deletion or configuration information updating; or sending, by the first network element, the control information to the second network element after the first network element receives a request for acquiring the configuration information.

Content is transmitted between the first network element and the second network element in at least one of the following formats: a container or a plaintext. The plaintext may be an application information element (AP IE) or the like. The content may be the control information, a request message or the like.

Optionally, generating, by the first network element, the control information according to the service type information includes configuring, by the first network element, the control information according to the service type information through at least one of a dedicated process or a common process.

Optionally, after sending, by the first network element, the control information to the second network element through the interface between the first network element and the second network element, the method further includes receiving, by the first network element, feedback information sent by the second network element in response to the control information.

Optionally, the feedback information includes at least one of feedback information for flow control, inter-layer state indication information, acknowledgement (ACK)/non-acknowledgement (NACK) state indication information, measurement result report information, or parameter information of an entity in the second network element.

The various kinds of configuration information in the embodiment are explained with examples hereinafter. The slice configuration information includes at least one of a mapping relationship between a slice and a radio bearer (RB), a mapping relationship between the slice and a logical channel (LCH), a mapping relationship between the slice and a service type, a mapping relationship between the slice and a physical resource or a physical resource pool, a slice priority, a quality of service (QoS) level of the slice, a maximum transmission rate of the slice, or a percentage of resources occupied by the slice. The numerology configuration information includes at least one of a mapping relationship between numerology and a radio bearer (RB), a mapping relationship between the numerology and a logical channel (LCH), a mapping relationship between the numerology and a service type, or a mapping relationship between the numerology and a physical resource or a physical resource pool. The grant-free configuration information includes at least one of a mapping relationship between grant-free and a radio bearer (RB), a mapping relationship between the grant-free and a logical channel (LCH), or a mapping relationship between the grant-free and a service type. The LCP configuration information includes at least one of a mapping relationship between an LCP and a radio bearer (RB), a mapping relationship between the LCP and a logical channel (LCH), or a mapping relationship between the LCP and a service type. The DRX configuration information includes at least one of a mapping relationship between DRX and a radio bearer (RB), a mapping relationship between the DRX and a logical channel (LCH), or a mapping relationship between the DRX and a service type. The HARQ configuration information includes at least one of a mapping relationship between an HARQ and a radio bearer (RB), a mapping relationship between the HARQ and a logical channel (LCH), or a mapping relationship between the HARQ and a service type. The BSR configuration information includes at least one of a BSR being reported in unit of logical channel group or the BSR being reported in unit of logical channel. The PHR configuration information includes at least one of a terminal being configured to calculate a power headroom according to total power or the terminal being configured to calculate the power headroom according to power allocated on multiple links.

From the description of the preceding implementation modes, it will be apparent to those skilled in the art that the method of the preceding embodiments may be implemented by use of software plus a necessary general-purpose hardware platform, or may, of course, be implemented by hardware, but in many cases, the former is a preferred implementation. Based on this understanding, the solution provided in the present disclosure substantially, or the part contributing to the existing art, may be embodied in the form of a software product. The software product is stored in a storage medium (such as a ROM/RAM, a magnetic disk or an optical disk) and includes several instructions for enabling a terminal (which may be a mobile phone, a computer, a server or a network device) to perform the method according to each embodiment of the present disclosure.

In an embodiment, a control signaling configuration apparatus is provided. The apparatus is used for implementing the preceding embodiments and preferred implementation modes. What has been described will not be repeated. As used below, the term “module” may be software, hardware or a combination thereof capable of implementing preset functions. The apparatus in the embodiment described below is preferably implemented by software, but implementation by hardware or by a combination of software and hardware is also possible and conceived.

FIG. 3 is a block diagram of the control signaling configuration apparatus according to the embodiment of the present disclosure. As shown in FIG. 3, the apparatus includes a generating module 30 and a sending module 32.

The generating module 30 is arranged to generate control information according to service type information.

The sending module 32 is arranged to send the control information to a second network element through an interface between a first network element and the second network element.

Alternatively, the generating module 30 is arranged to generate control information.

Optionally, the service type information includes at least one of a service type, a radio bearer (RB), a logical channel (LCH), a physical-layer parameter numerology, or a network slice. The physical layer parameter numerology includes at least one of a subcarrier spacing, a symbol interval, a subframe format, a quantity of symbols included in a subframe, a multi-access mode, or a transmission time interval.

Optionally, the control information includes configuration information. The configuration information includes at least one of slice configuration information, numerology configuration information, grant-free configuration information, logic channel priority (LCP) configuration information, discontinuous reception (DRX) configuration information, hybrid automatic repeat request (HARQ) configuration information, buffer status report (BSR) configuration information, power headroom report (PHR) configuration information, or measurement configuration information.

Optionally, the generating unit is configured to generate the control information according to the service type information when at least one of configuration information addition, configuration information deletion or configuration information updating is performed.

Optionally, the sending module includes a first sending unit, which is arranged to send the control information to the second network element after at least one of configuration information addition, configuration information deletion or configuration information updating is performed, or a second sending unit, which is arranged to make the first network element send the control information to the second network element after a request for acquiring the configuration information is received.

It is to be noted that the various modules described above may be implemented by software or hardware. Implementation by hardware may, but may not necessarily, be performed in following manners: the various modules described above are located in a same processor; or, in any combination, the various modules are located in different processors.

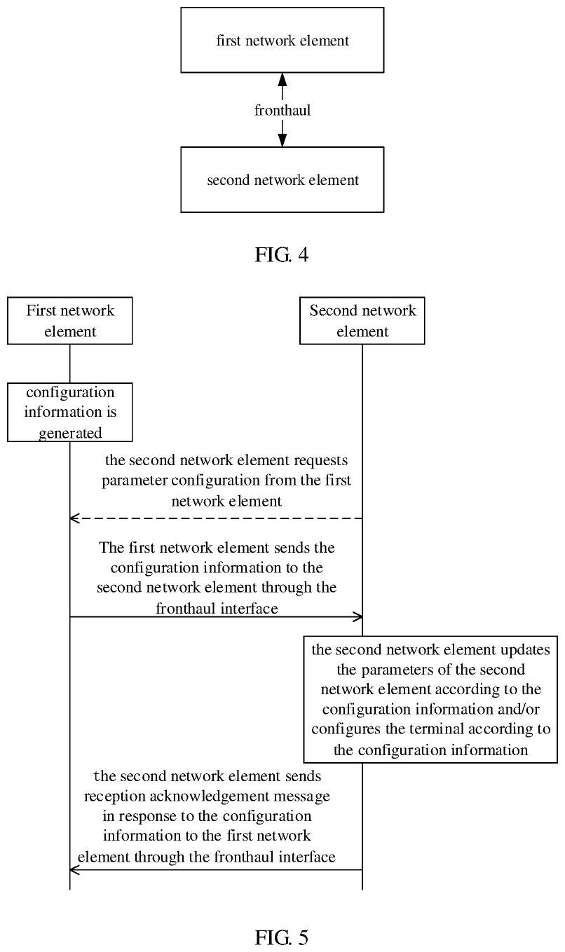

FIG. 4 is a schematic diagram of a fronthaul interface between a first network element and a second network element according to the present disclosure. In FIG. 4, information is exchanged between the first network element and the second network element through the fronthaul interface. The fronthaul may be an ideal fronthaul or a non-ideal fronthaul depending on different delays. The transmission delay of the ideal fronthaul is relatively small, for example, about tens to hundreds of microseconds. The transmission delay of the non-ideal fronthaul is relatively large, for example, milliseconds. Because of the distinction between the ideal fronthaul and the non-ideal fronthaul, the first network element and the second network element have different functions. That is, in the case of non-ideal fronthaul transmission, it is needed to place delay-sensitive user plane functions, for example, a function closely related to scheduling, in the second network element, and it is needed to place delay-insensitive functions, for example, header compression, encryption, and integrity inclusion, in the first network element, thereby satisfying transmission delay requirement. In addition, a first control plane protocol entity (for example, a radio resource control (RRC) entity) is in the first network element, so the parameter configuration of the second network element and/or the configuration of a terminal also needs to be notified to the second network element by the first network element through the fronthaul interface.

Since there is the fronthaul interface between the first network element and the second network element, a control message generated for the first network element needs to be understood by the second network element and the content of a message fed back by the second network element needs to be understood by the first network element. To solve the preceding problem, it is needed to define and standardize an information unit (IE) transmitted over the interface. On this basis, a control signaling configuration method is provided to define the type of a control message transmitted over the interface between the first network element and the second network element.

Table 1 lists a mapping relationship between slice and/or numerology and/or HARQ and/or DRX and radio bearer (RB) and/or logical channel (LCH) and/or service type. The mapping relationship is configured for the second network element by the first network element through the fronthaul interface.

TABLE 1

| | | |
|---|---|---|
| slice1/numerology1/HARQ1/DRX1 | RB1/LCH1/service | |
| | type 1 | |
| | . . . | optional |
| | RB(p)/LCH(q)/service | optional |
| | type (o) | |
| slice2/numerology2/HARQ2/DRX2 | RB(k)/LCH(j)/service | |
| | type (i) | |
| | . . . | optional |
| | RB(m)/LCH(n)/service | optional |
| | type (l) | |

. . .

The embodiment includes several examples in which the present application is described in detail in conjunction with different scenarios.

### EXAMPLE 1

FIG. 5 is a flowchart of transmission of configuration information between a first network element and a second network element according to the present disclosure. The first network element generates the configuration information according to service type information, and sends the configuration information to the second network element through a fronthaul interface. The second network element updates a parameter according to the configuration information and/or configures a terminal according to the configuration information. The first network element may be a centralized unit (CU). The second network element may be a distributed unit (DU). Detailed steps are described below.

In step 1, the configuration information is generated.

The configuration information includes at least one of slice configuration information, numerology configuration information, grant-free configuration information, LCP configuration information, DRX configuration information, HARQ configuration information, BSR configuration information, or PHR configuration information.

A triggering condition for generating the configuration information includes at least one of configuration information addition, configuration information deletion, configuration information updating, or reception of a parameter configuration request from the second network element.

In step 2, the first network element sends the configuration information to the second network element through the fronthaul interface.

The first network element includes at least one of a first control plane protocol entity, a second protocol entity, a third protocol entity, a fourth protocol entity, or a physical layer.

The second network element includes at least one of a second protocol entity, a third protocol entity, a fourth protocol entity, a physical layer, or a radio frequency unit.

One first network element manages one or more second network elements. That is, one first network element sends the configuration information to one or more second network elements.

The configuration information is sent to the second network element by the first network element when configuration information addition, configuration information deletion, configuration information updating is performed.

Optionally, the configuration information is sent to the second network element in a case that the second network element sends a parameter configuration request to the first network element.

In step 3, the second network element updates a parameter of the second network element according to the configuration information and/or configures a terminal according to the configuration information.

The second network element configures an entity in the second network element according to the configuration information.

Alternatively, the second network element configures the terminal according to the configuration information.

In step 4, the second network element sends a reception acknowledgement message in response to the configuration information to the first network element through the fronthaul interface.

The acknowledgement message is generated by the second network element or by the terminal.

After receiving the reception acknowledgement message in response to the configuration information, the first network element stops a repeated transmission of the configuration information.

It is to be noted that step 4 corresponding to a process of sending the configuration information for deletion or release is optional. That is, an acknowledgement feedback process may be absent for sending the configuration information for deletion or release.

### EXAMPLE 2

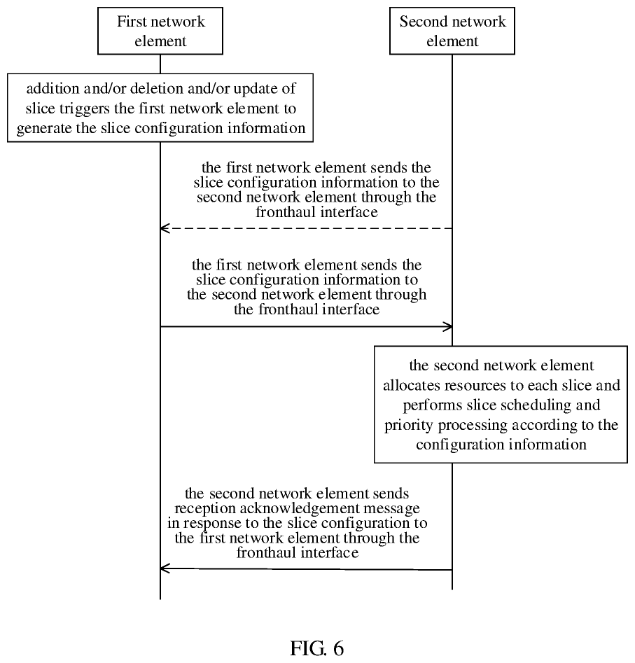

FIG. 6 is a flowchart of generation and/or transmission of slice configuration information according to the present disclosure. A first network element generates configuration information of one or more slices in unit of slice, and sends the configuration information to a second network element through a fronthaul interface. The second network element performs centralized management and scheduling on the one or more slices according to the configuration information to achieve isolation between slices and avoid interference between slices. Detailed steps are described below.

In step 1, at least one of slice addition, slice deletion or slice updating triggers the first network element to generate the slice configuration information.

The configuration information includes a mapping relationship between a slice and a radio bearer (RB) and/or a logical channel (LCH), a resource required by the slice, a slice priority, and a QoS level of the slice.

A triggering condition for generating the configuration information includes at least one of slice addition, slice deletion or slice updating.

One slice includes one or more RBs and/or LCHs. See Table 1.

The fourth protocol entity in the second network element allocates resources to one or more slices and performs priority processing of slices according to the configuration information.

The resource required by the slice is used for indicating the size of a resource block that the fourth protocol entity in the second network element needs to reserve for the slice.

The slice priority is used for indicating a priority sequence of scheduling the slice by the fourth protocol entity in the second network element.

The QoS level of the slice is used for instructing the fourth protocol entity in the second network element to perform scheduling processing of the slice according to the QoS level.

The fourth protocol entity has a scheduling function that centrally manages and schedules one or more slices.

The slices are divided based on different radio bearers, based on different cells and/or frequencies, or based on different service types.

In step 2, the first network element sends the slice configuration information to the second network element through the fronthaul interface.

An information unit (IE) transmitted through the fronthaul interface includes a mapping relationship between a slice and an RB and/or an LCH, a resource required by the slice, a slice priority, and a QoS level of the slice.

The configuration information is sent by the first network element to the second network element when at least one of slice addition, slice deletion or slice updating is performed.

Optionally, the second network element sends a slice configuration request to the first network element through the fronthaul interface.

A wired transmission mode or a wireless transmission mode is used between the first network element and the second network element.

The fronthaul may be an ideal fronthaul or a non-ideal fronthaul depending on different delay requirements.

In step 3, the second network element allocates the resource to each slice and performs slice scheduling and priority processing according to the configuration information.

The configuration information includes a mapping relationship between a slice and an RB and/or an LCH, a resource required by the slice, a slice priority, and a QoS level of the slice.

The fourth protocol entity in the second network element determines the mapping relationship between the slice and the RB and/or the LCH according to the configuration information.

The fourth protocol entity allocates a resource block of a predetermined size to each slice and performs scheduling and priority processing according to scheduling information in the configuration information to achieve inter-slice isolation and avoid inter-slice interference.

If the configuration information is deletion of a slice, the corresponding slice resource is released.

In step 4, the second network element sends a reception acknowledgement message in response to the slice configuration to the first network element through the fronthaul interface.

After receiving the reception acknowledgement message in response to the slice configuration information, the first network element stops repeated transmission of the slice configuration information.

It is to be noted that step 4 corresponding to a process of sending the configuration information for slice deletion or slice release is optional. That is, an acknowledgement feedback process may be absent for sending he configuration information for slice deletion or slice release.

### EXAMPLE 3

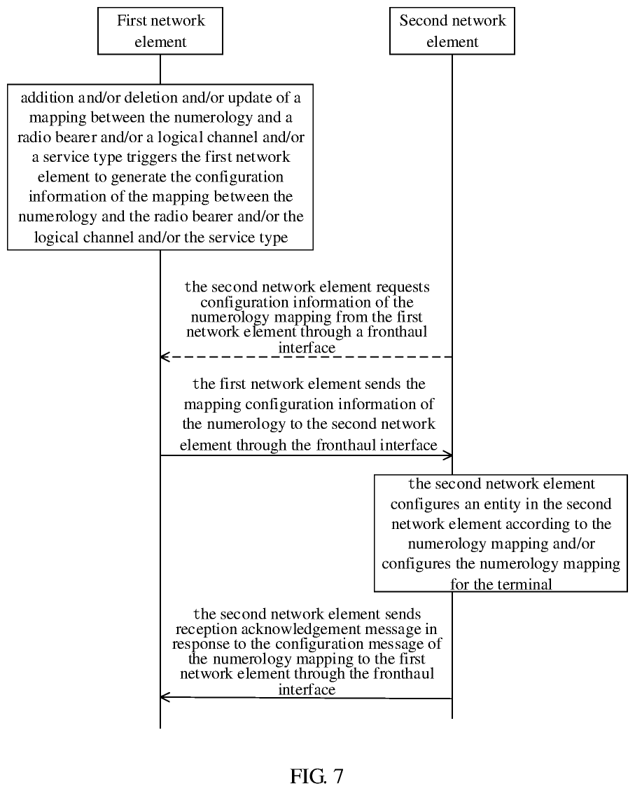

FIG. 7 is a flowchart of configuration of numerology mapping relationship according to the present disclosure. A first network element sends numerology configuration information to a second network element in a high-layer signaling semi-static manner. The second network element updates parameters of entities in the second network element according to the configuration information and/or the second network element configures a terminal according to the configuration information. Detailed steps are described below.

In step 1, the addition and/or deletion and/or updating of a mapping relationship between the numerology and a radio bearer and/or a logical channel and/or a service type triggers the first network element to generate the configuration information of the mapping relationship between the numerology and the radio bearer and/or the logical channel and/or the service type.

The physical layer parameter numerology includes at least one of a subcarrier spacing, a symbol interval, a subframe format, a quantity of symbols included in a subframe, a multi-access mode, or a transmission time interval.

A semi-static configuration manner means that the numerology configuration information is carried in an L3 control message and/or an L2 control message, and a base station configures the numerology configuration information to the second network element by using the L3 control message and/or the L2 control message.

In one example, the second network element sends the configuration information to a terminal.

The generation and/or transmission of the L3 control message and/or the L2 control message including the numerology configuration information is triggered by changes in the numerology of different service types.

Optionally, the second network element requests for configuration information of the numerology mapping relationship from the first network element through a fronthaul interface.

The L3 control information may be an RRC control message.

The L2 control information may be a MAC control message MAC CE.

In step 2, the first network element sends the mapping relationship configuration information of the numerology to the second network element through the fronthaul interface.

In step 3, the second network element configures an entity in the second network element according to the numerology mapping relationship and/or configures the numerology mapping relationship to the terminal.

The numerology configuration information is used for instructing the terminal to receive and demodulate data by using numerology configuration parameters.

The second network element dynamically indicates, by using downlink control information (DCI), which set of numerology configuration parameters the terminal uses, or the terminal itself selects, according to the service type, which set of numerology configuration parameters to be used.

If the configuration information is deletion of a numerology mapping relationship, the corresponding numerology resource is released.

In step 4, the second network element sends a reception acknowledgement message in response to the configuration message of the numerology mapping relationship to the first network element through the fronthaul interface.

The feedback message is generated by the second network element or by the terminal.

After receiving the reception acknowledgement message in response to the numerology configuration information, the first network element stops repeated transmission of the numerology configuration information.

It is to be noted that step 4 corresponding to a process of sending the configuration information of numerology deletion or numerology release is optional. That is, an acknowledgement feedback process may be absent for sending the configuration information of numerology deletion or numerology release.

### EXAMPLE 4

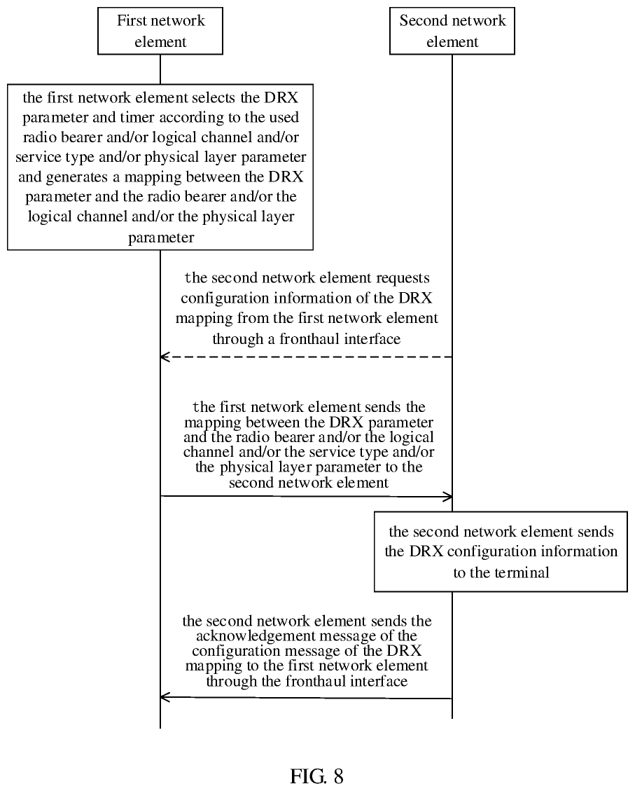

FIG. 8 is a flowchart of configuration of DRX mapping relationship according to the present disclosure. A terminal performs multiple services simultaneously. Different services are mapped to different radio bearers and/or logical channels. The first network element selects a DRX parameter and a timer for the terminal according to a radio bearer and/or a logical channel and/or a service type used by the terminal. Detailed steps are described below.

In step 1, a first network element selects the DRX parameter and the timer according to the used radio bearer and/or logical channel and/or service type and/or physical layer parameter and generates a mapping relationship between the DRX parameter and the radio bearer and/or the logical channel and/or the physical layer parameter.

The physical layer parameter includes at least one of a subcarrier spacing, a symbol interval, a subframe format, a quantity of symbols included in a subframe, a multi-access mode, or a transmission time interval.

The DRX parameter and the timer are selected according to the radio bearer and/or logical channel and/or service type and/or physical layer parameter so that the mapping between the DRX parameter and the radio bearer and/or the logical channel and/or the physical layer parameter is achieved. The mapping is sent to the second network element by the first network element through an interface between the first network element and the second network element, and is further configured to the terminal by the second network element.

The radio bearer and/or logical channel and/or physical layer parameter is associated with the service type. That is, different services are mapped to corresponding radio bearers and/or logical channels, and different physical layer parameters are used according to different service characteristics.

The update of the DRX configuration parameter is triggered by a change in the service type and/or the logical channel and/or the radio bearer and/or the physical layer parameter.

The transmission of the DRX configuration parameter is triggered by a change in the service type and/or the logical channel and/or the radio bearer and/or the physical layer parameter.

Optionally, the second network element requests for configuration information of the DRX mapping relationship from the first network element through a fronthaul interface.

In step 2, the first network element sends the mapping relationship between the DRX parameter and the radio bearer and/or the logical channel and/or the service type and/or the physical layer parameter to the second network element.

The first network element sends the DRX configuration information corresponding to each service to the second network element in manners described below.

Manner 1: The first network element semi-statically sends the DRX configuration information to the second network element through a first control plane protocol entity (for example, a radio resource control (RRC) entity).

Manner 2: The first network element semi-statically sends the DRX configuration information to the second network element through a fourth protocol entity (for example, a MAC CE).

Further, the second network element sends the DRX configuration information to the terminal.

The second network element dynamically indicates, by using DCI, which set of DRX configuration parameters the terminal uses, or the terminal itself selects, according to the service type, which set of DRX configuration parameters to be used.

The service type may be classified according to requirements on, e.g. a transmission rate and/or a delay and/or reliability, and may include, but not limited to, at least one of enhanced Mobile Broadband (eMBB), massive Machine Type Communications (mMTC), or Ultra-Reliable and Low Latency Communications (URLLC).

If the configuration information is deletion of DRX, the corresponding DRX resource is released.

In step 3, the second network element sends a reception acknowledgement message in response to the configuration message of the DRX mapping relationship to the first network element through the fronthaul interface.

The acknowledgement message is generated by the second network element or by the terminal.

The reception acknowledgement message is used for informing the first network element of the receiving state of the DRX configuration information. That is, the reception acknowledgement message is used for indicating whether the DRX configuration information needs to be retransmitted by the first network element.

It is to be noted that step 4 corresponding to a process of sending the configuration information for DRX deletion or DRX release is optional. That is, an acknowledgement feedback process may be absent for sending the configuration information for DRX deletion or DRX release.

### EXAMPLE 5

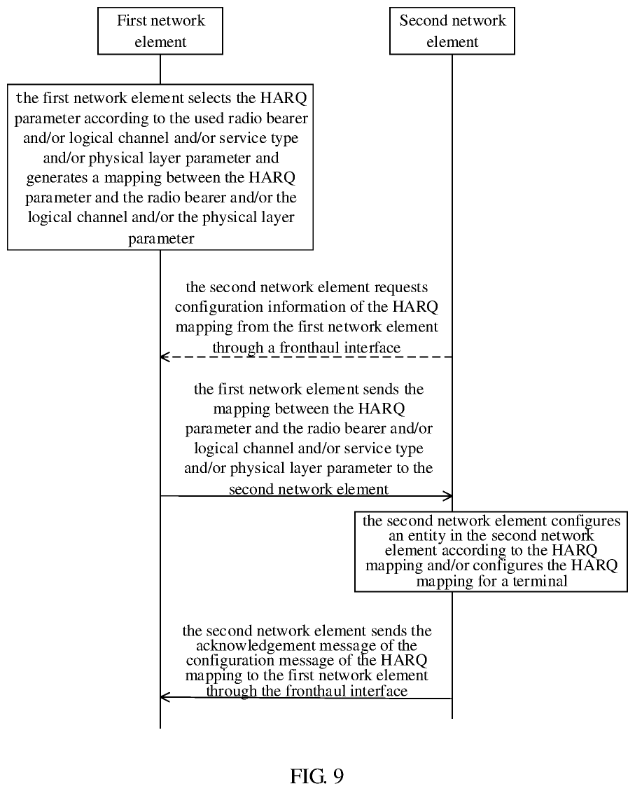

FIG. 9 is a flowchart of configuration of HARQ mapping relationship according to the present disclosure. In the example, a first network element generates a mapping table for different service types and HARQ configuration parameters, and sends the mapping table to a second network element through an interface between the first network element and the second network element. Detailed steps are described below.

In step 1, the first network element selects the HARQ parameter according to the used radio bearer and/or logical channel and/or service type and/or physical layer parameter and generates a mapping between the HARQ parameter and the radio bearer and/or the logical channel and/or the physical layer parameter.

The physical layer parameter includes at least one of a subcarrier spacing, a symbol interval, a subframe format, a quantity of symbols included in a subframe, a multi-access mode, or a transmission time interval.

The first network element selects the HARQ parameter according to the radio bearer and/or logical channel and/or service type and/or physical layer parameter and/or slice and generates the mapping table between the HARQ parameter and the radio bearer and/or logical channel and/or service type and/or physical layer parameter and/or slice. The mapping table is shown in Table 1. The update of the HARQ configuration parameter is triggered by a change in the radio bearer and/or logical channel and/or service type and/or physical layer parameter and/or slice information.

Optionally, the second network element requests for configuration information of the HARQ mapping relationship from the first network element through a fronthaul interface.

In step 2, the first network element sends the mapping relationship between the HARQ parameter and the radio bearer and/or logical channel and/or service type and/or physical layer parameter to the second network element.

The first network element semi-statically sends the HARQ configuration information to the second network element through a first control plane protocol entity (for example, a radio resource control (RRC) entity).

The first network element semi-statically sends the HARQ configuration information to the second network element through a fourth protocol entity control unit (for example, a MAC CE).

In step 3, the second network element configures an entity in the second network element according to the HARQ mapping relationship and/or configures the HARQ mapping relationship to a terminal.

The second network element updates the parameter configuration of its own entities according to the HARQ configuration information.

The second network element sends the HARQ configuration information to the terminal.

The second network element dynamically indicates, by using DCI, which set of HARQ configuration parameters the terminal uses, or the terminal itself selects, according to the service type, which set of HARQ configuration parameters to be used.

The service type may be classified according to requirements on, e.g., a transmission rate and/or a delay and/or reliability, and may include, but not limited to, at least one of eMBB, mMTC, or URLLC.

The terminal determines the HARQ configuration parameter corresponding to the service according to the currently used service type information and the mapping relationship.

If the configuration information is deletion of HARQ, the corresponding HARQ resource is released.

In step 4, the second network element sends a reception acknowledgement message in response to the configuration message of the HARQ mapping relationship to the first network element through the fronthaul interface.

The reception acknowledgement message is generated by the second network element or by the terminal.

The reception acknowledgement message is used for informing the first network element of the receiving state of the HARQ configuration information. That is, the reception acknowledgement message is used for indicating whether the HARQ configuration information needs to be retransmitted by the first network element.

It is to be noted that step 4 corresponding to a process of sending the configuration information for HARQ deletion or HARQ release is optional. That is, an acknowledgement feedback process may be absent for sending the configuration information for HARQ deletion or HARQ release.

### EXAMPLE 6

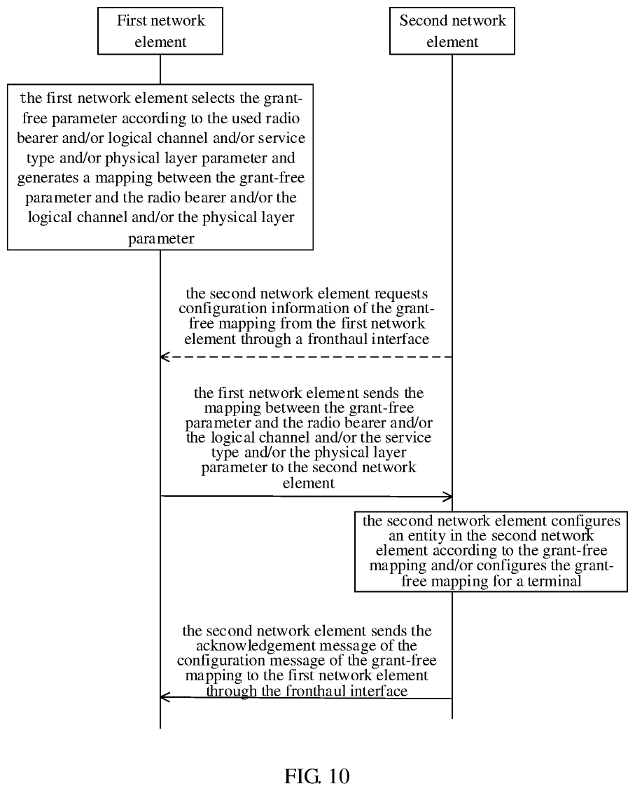

FIG. 10 is a flowchart of configuration of grant-free mapping relationship according to the present disclosure. In the example, a first network element generates a mapping table for different service types and grant-free configuration parameters, and sends the mapping table to a second network element through an interface between the first network element and the second network element. Detailed steps are described below.

In step 1, the first network element selects the grant-free parameter according to the used radio bearer and/or logical channel and/or service type and/or physical layer parameter and generates a mapping between the grant-free parameter and the radio bearer and/or the logical channel and/or the physical layer parameter.

The physical layer parameter includes at least one of a subcarrier spacing, a symbol interval, a subframe format, a quantity of symbols included in a subframe, a multi-access mode, or a transmission time interval.

The first network element selects the grant-free parameter according to the radio bearer and/or logical channel and/or service type and/or physical layer parameter and/or slice and generates the mapping table between the grant-free parameter and the radio bearer and/or logical channel and/or service type and/or physical layer parameter and/or slice. The update of the grant-free configuration parameter is triggered by a change in the radio bearer and/or logical channel and/or service type and/or physical layer parameter and/or slice information.

Optionally, the second network element requests for configuration information of the grant-free mapping relationship from the first network element through a fronthaul interface.

In step 2, the first network element sends the mapping relationship between the grant-free parameter and the radio bearer and/or the logical channel and/or the service type and/or the physical layer parameter to the second network element.

The first network element semi-statically sends the grant-free configuration information to the second network element through a first control plane protocol entity (for example, a radio resource control (RRC) entity).

The first network element semi-statically sends the grant-free configuration information to the second network element through a fourth protocol entity control unit (for example, a MAC CE).

In step 3, the second network element configures an entity in the second network element according to the grant-free mapping relationship and/or configures the grant-free mapping relationship to a terminal.

The second network element updates the parameter configuration of its own entities according to the grant-free configuration information.

The second network element sends the grant-free configuration information to the terminal.

The second network element dynamically indicates, by using DCI, which set of grant-free configuration parameters the terminal uses, or the terminal itself selects, according to the service type, which set of grant-free configuration parameters to be used.

The service type may be classified according to requirements on, e.g., a transmission rate and/or a delay and/or reliability,and may include, but not limited to, at least one of eMBB, mMTC, or URLLC.

The terminal determines the grant-free configuration parameter corresponding to the service according to the currently used service type information and the mapping relationship.

If the configuration information is deletion of grant-free, the corresponding grant-free resource is released.

In step 4, the second network element sends a reception acknowledgement message in response to the configuration message of the grant-free mapping relationship to the first network element through the fronthaul interface.

The reception acknowledgement message is generated by the second network element or by the terminal.

The reception acknowledgement message is used for informing the first network element of the receiving state of the grant-free configuration information. That is, the reception acknowledgement message is used for indicating whether the grant-free configuration information needs to be retransmitted by the first network element.

It is to be noted that step 4 corresponding to a process of sending the configuration information for grant-free deletion or grant-free release is optional. That is, an acknowledgement feedback process may be absent for sending the configuration information of grant-free deletion or grant-free release.

### EXAMPLE 7

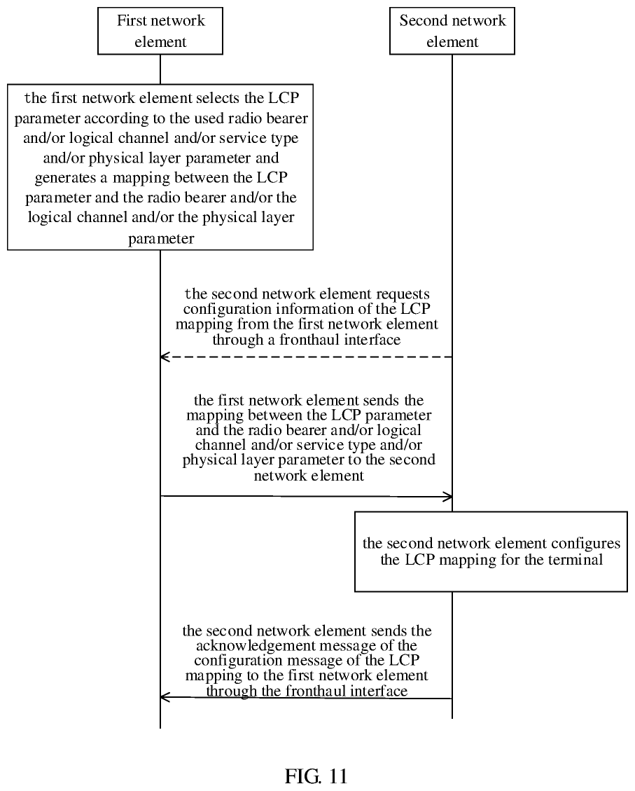

FIG. 11 is a flowchart of configuration of LCP mapping relationship according to the present disclosure. In the example, a first network element generates a mapping table for different service types and LCP configuration parameters, and sends the mapping table to a second network element through an interface between the first network element and the second network element. Detailed steps are described below.

In step 1, the first network element selects the LCP parameter according to the used radio bearer and/or logical channel and/or service type and/or physical layer parameter and generates a mapping between the LCP parameter and the radio bearer and/or the logical channel and/or the physical layer parameter.

The physical layer parameter includes at least one of a subcarrier spacing, a symbol interval, a subframe format, a quantity of symbols included in a subframe, a multi-access mode, or a transmission time interval.

The first network element selects the LCP parameter according to the radio bearer and/or logical channel and/or service type and/or physical layer parameter and/or slice and generates the mapping table between the LCP parameter and the radio bearer and/or logical channel and/or service type and/or physical layer parameter and/or slice. The update of the LCP configuration parameter is triggered by a change in the radio bearer and/or logical channel and/or service type and/or physical layer parameter and/or slice information.

Optionally, the second network element requests for configuration information of the LCP mapping relationship from the first network element through a fronthaul interface.

In step 2, the first network element sends the mapping relationship between the LCP parameter and the radio bearer and/or logical channel and/or service type and/or physical layer parameter to the second network element.

The first network element semi-statically sends the LCP configuration information to the second network element through a first control plane protocol entity (for example, a radio resource control (RRC) entity).

The first network element semi-statically sends the LCP configuration information to the second network element through a fourth protocol entity control unit (for example, a MAC CE).

In step 3, the second network element configures an entity in the second network element according to the LCP mapping relationship and/or configures the LCP mapping relationship to the terminal.

The second network element updates the parameter configuration of its own entities according to the LCP configuration information.

The second network element sends the LCP configuration information to the terminal.

The second network element dynamically indicates, by using DCI, which set of LCP configuration parameters the terminal uses, or the terminal itself selects, according to the service type, which set of LCP configuration parameters to be used.

The service type may be classified according to requirements on, e.g., a transmission rate and/or a delay and/or reliability, and may include, but not limited to, at least one of eMBB, mMTC, or URLLC.

The terminal determines the LCP configuration parameter corresponding to the service according to the currently used service type information and the mapping relationship.

If the configuration information is deletion of LCP, the corresponding LCP resource is released.

In step 4, the second network element sends a reception acknowledgement message in response to the configuration message of the LCP mapping relationship to the first network element through the fronthaul interface.

The reception acknowledgement message is generated by the second network element or by the terminal.

The reception acknowledgement message is used for informing the first network element of the receiving state of the LCP configuration information. That is, the reception acknowledgement message is used for indicating whether the LCP configuration information needs to be retransmitted by the first network element.

It is to be noted that step 4 corresponding to a process of sending the configuration information for LCP deletion or LCP release is optional. That is, an acknowledgement feedback process may be absent for sending the configuration information for LCP deletion or LCP release.

### EXAMPLE 8

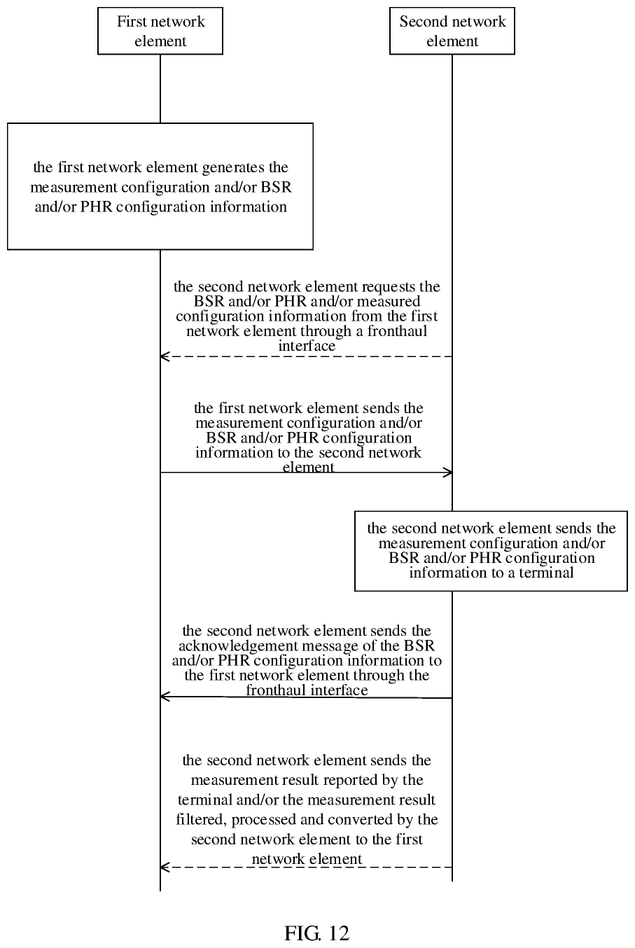

FIG. 12 is a flowchart of transmission of configuration information of BSR/PHR/measurement configuration according to the present disclosure. In the example, a first network element generates measurement configuration and/or BSR and/or PHR configuration information, and sends the mapping table to a second network element through an interface between the first network element and the second network element. Further, the second network element sends the configuration information to a terminal. Detailed steps are described below.

In step 1, the first network element generates the measurement configuration and/or BSR and/or PHR configuration information.

The BSR configuration information includes at least one of a BSR being reported in unit of logical channel group or a BSR being reported in unit of logical channel.

The PHR configuration information includes at least one of a terminal being configured to calculate a power headroom according to total power or the terminal being configured to calculate the power headroom according to power allocated on multiple links.

The measurement configuration includes at least one of a measurement object, a triggering reporting configuration, a measurement identifier, a measurement gap, or configuring whether the terminal performs cell measurement or beam measurement.

In step 2, the first network element sends the measurement configuration and/or BSR and/or PHR configuration information to the second network element.

The first network element configures a BSR and/or PHR and/or measurement reporting mode according to a connection mode of the terminal, for example, single-link or multi-link.

Optionally, the first network element configures, according to a frequency level, whether the terminal performs cell-level or beam-level measurement.

Optionally, the first network element configures the BSR and/or PHR and/or measurement reporting mode according to a current service of the terminal.

Optionally, the second network element requests for the BSR configuration information and/or PHR configuration information and/or measurement configuration information from the first network element through a fronthaul interface.

In step 3, the second network element sends a reception acknowledgement message in response to the BSR and/or PHR configuration information to the first network element through the fronthaul interface.

The reception acknowledgement message is generated by the second network element or by the terminal.

The reception acknowledgement message is used for informing the first network element of the receiving state of the BSR and/or PHR configuration information. That is, the reception acknowledgement message is used for indicating whether the BSR and/or PHR configuration information needs to be retransmitted.

In step 4, the second network element sends the measurement result reported by the terminal and/or the measurement result filtered, processed and converted by the second network element to the first network element.

The second network element sends the measurement result reported by the terminal to the first network element.

Alternatively, the second network element performs filtering processing according to the measurement result reported by the terminal, and sends the converted measurement result to the first network element. For example, the second network element converts a beam measurement result of the terminal to a cell measurement result, and then reports the cell measurement result to the first network element.

In an embodiment of the present disclosure, a storage medium is provided. Optionally, in the embodiment, the storage medium may be arranged to store program codes for performing steps described below.

In S1, control information is generated according to service type information.

In S2, the control information is sent to a second network element through an interface between a first network element and the second network element.

Optionally, in the embodiment, the storage medium may include, but is not limited to, a U disk, a read-only memory (ROM), a random access memory (RAM), a mobile hard disk, a magnetic disk, an optical disk or any other medium capable of storing program codes.

Optionally, in the embodiment, a processor generates the control information according to the service type information by executing the program codes stored in the storage medium.

Optionally, in the embodiment, the processor sends the control information to the second network element through the interface between the first network element and the second network element according to the service type information by executing the program codes stored in the storage medium.

Optionally, for specific examples in the embodiment, reference may be made to the examples described in the preceding embodiments and optional implementation modes, and the specific examples will not be repeated in the embodiment.

Apparently, those skilled in the art should know that each preceding module or step of the present disclosure may be implemented by a universal computing device, they may be concentrated on a single computing device or distributed in a network formed by multiple computing devices, and alternatively, they may be implemented by program codes executable by the computing devices, so that they may be stored in a storage device for execution by the computing devices, and in some circumstances, the illustrated or described steps may be executed in sequences different from those described herein, or they may be made into various integrated circuit modules separately, or multiple modules or steps therein may be made into a single integrated circuit module for implementation. Therefore, the present disclosure is not limited to any specific combination of hardware and software.

The above are only preferred embodiments of the present disclosure and are not intended to limit the present disclosure, and for those skilled in the art, the present disclosure may have various modifications and variations. Any modifications, equivalent substitutions, improvements and the like made within the spirit and principle of the present disclosure are within the scope of the present disclosure.

### INDUSTRIAL APPLICABILITY

The present disclosure is applicable to the field of communications and is used for solving the problem in related technology that network elements cannot understand each other, thereby improving the service processing efficiency of the network elements.

1. A control signaling configuration method, comprising:
generating, by a first network element, control information; and
sending, by the first network element, the control information to a second network element through an interface between the first network element and the second network element.

2. (canceled)

3. The control signaling configuration method of claim 1, wherein the control information comprises configuration information, wherein the configuration information comprises at least one of:
slice configuration information, numerology configuration information, grant-free configuration information, logic channel priority (LCP) configuration information, discontinuous reception (DRX) configuration information, hybrid automatic repeat request (HARQ) configuration information, buffer status report (BSR) configuration information, power headroom report (PHR) configuration information, or measurement configuration information.

4. (canceled)

5. The control signaling configuration method of claim 3, wherein the sending, by the first network element, the control information to the second network element through the interface between the first network element and the second network element comprises:
sending, by the first network element, the control information to the second network element after the first network element performs at least one of configuration information addition, configuration information deletion or configuration information updating; or
sending, by the first network element, the control information to the second network element after the first network element receives a request for acquiring the configuration information.

6. (canceled)

7. The control signaling configuration method of claim 1, wherein after the sending, by the first network element, the control information to the second network element through the interface between the first network element and the second network element, the control signaling configuration method further comprises:
receiving, by the first network element, feedback information sent by the second network element in response to the control information.

8. The control signaling configuration method of claim 7, wherein the feedback information comprises at least one of feedback information for flow control, inter-layer state indication information, acknowledgement (ACK)/non-acknowledgement (NACK) state indication information, measurement result report information, or parameter information of an entity in the second network element.

9. The control signaling configuration method of claim 3, wherein the slice configuration information comprises at least one of a mapping relationship between a slice and a radio bearer (RB), a mapping relationship between the slice and a logical channel (LCH), a mapping relationship between the slice and a service type, a mapping relationship between the slice and a physical resource or a physical resource pool, a slice priority, a quality of service (QoS) level of the slice, a maximum transmission rate of the slice, or a percentage of resources occupied by the slice.

10. The control signaling configuration method of claim 3, wherein the numerology configuration information comprises at least one of a mapping relationship between numerology and a radio bearer (RB), a mapping relationship between the numerology and a logical channel (LCH), a mapping relationship between the numerology and a service type, or a mapping relationship between the numerology and a physical resource or a physical resource pool.

11. The control signaling configuration method of claim 3, wherein the grant-free configuration information comprises at least one of a mapping relationship between grant-free and a radio bearer (RB), a mapping relationship between the grant-free and a logical channel (LCH), or a mapping relationship between the grant-free and a service type.

12. The control signaling configuration method of claim 3, wherein the LCP configuration information comprises at least one of a mapping relationship between an LCP and a radio bearer (RB), a mapping relationship between the LCP and a logical channel (LCH), or a mapping relationship between the LCP and a service type.

13. The control signaling configuration method of claim 3, wherein the DRX configuration information comprises at least one of a mapping relationship between DRX and a radio bearer (RB), a mapping relationship between the DRX and a logical channel (LCH), or a mapping relationship between the DRX and a service type.

14. The control signaling configuration method of claim 3, wherein the HARQ configuration information comprises at least one of a mapping relationship between an HARQ and a radio bearer (RB), a mapping relationship between the HARQ and a logical channel (LCH), or a mapping relationship between the HARQ and a service type.

15. The control signaling configuration method of claim 3, wherein the BSR configuration information comprises at least one of a BSR being reported in unit of logical channel group or the BSR being reported in unit of logical channel.

16. The control signaling configuration method of claim 3, wherein the PHR configuration information comprises at least one of a terminal being configured to calculate a power headroom according to total power or the terminal being configured to calculate the power headroom according to power allocated on a plurality of links.

17. The control signaling configuration method of claim 1, wherein content is transmitted between the first network element and the second network element in at least one of the following formats: a container or a plaintext.

18. The control signaling configuration method of claim 1, wherein the first network element and the second network element are defined according to at least one of different processing delay requirements, different transmission capacity requirements, or different service types.

19. A control signaling configuration apparatus, comprising:
a generating module, which is configured to generate control information; and
a sending module, which is configured to send the control information to a second network element through an interface between a first network element and the second network element.

20. (canceled)

21. The control signaling configuration apparatus of claim 19, wherein the control information comprises configuration information, wherein the configuration information comprises at least one of:
slice configuration information, numerology configuration information, grant-free configuration information, logic channel priority (LCP) configuration information, discontinuous reception (DRX) configuration information, hybrid automatic repeat request (HARQ) configuration information, buffer status report (BSR) configuration information, power headroom report (PHR) configuration information, or measurement configuration information.

22. (canceled)

23. The control signaling configuration apparatus of claim 21, wherein the sending module comprises:
a first sending unit, which is configured to send the control information to the second network element after at least one of configuration information addition, configuration information deletion or configuration information updating is performed, or
a second sending unit, which is configured to make the first network element send the control information to the second network element after a request for acquiring the configuration information is received.

24-38. (canceled)

39. The control signaling configuration apparatus of claim 19, wherein after the sending module sends the control information to the second network element through the interface between the first network element and the second network element, the control signaling configuration apparatus further receives feedback information sent by the second network element in response to the control information.

40. The control signaling configuration apparatus of claim 39, wherein the feedback information comprises at least one of feedback information for flow control, inter-layer state indication information, acknowledgement (ACK)/non-acknowledgement (NACK) state indication information, measurement result report information, or parameter information of an entity in the second network element.
